(19) United States
(12) Patent Application Publication
(10) Pub. No.: US 2014/0101284 A1
(43) Pub. Date: Apr. 10, 2014

(54) SYSTEM AND METHOD FOR CUSTOMIZATION OF WEB CONTENT

(71) Applicant: M/s MobileMotion Techonologies Private Limited, Bengaluru (IN)

(72) Inventors: Ravi Pratap MADDIMSETTY, Bengaluru (IN); Shivansh TYAGI, Bengaluru (IN); Bhashkar SHARMA, Bengaluru (IN); Ravish MISHRA, Bengaluru (IN)

(73) Assignee: M/s MobileMotion Technologies Private Limited, Bengaluru (IN)

(21) Appl. No.: 14/016,424

(22) Filed: Sep. 3, 2013

Related U.S. Application Data
(60) Provisional application No. 61/695,480, filed on Aug. 31, 2012.

(51) Int. Cl. H04L 29/06

(52) U.S. Cl. CPC H04L 65/602
USPC 709/217

(57) ABSTRACT

The present invention provides a method and system for customizing web content for a mobile computing device associated with a user over a network. The method and system include receiving a request for web content from the mobile computing device associated with the user and parsing acquired web content into separate one or more component parts based on the received request. The acquired web content is collected from a publisher of one or more publishers. Further, the method and system include storing the separated one or more component parts individually for the publisher of the one or more publishers, determining display capability of a browsing entity residing on the mobile computing device and enabling customization of the separated one or more component parts of the web content based on the determined display capability. Accordingly, the user views the customized web content.

### CROSS-REFERENCE TO RELATED APPLICATIONS

This application claimed priority to Provisional Application Ser. No. 61/695,480 filed Aug. 31, 2012, the contents of which are hereby incorporated by reference.

### FIELD OF THE INVENTION

The present invention relates to methods and systems for displaying web content, and more particularly, relates to methods and systems for displaying customized web content on mobile devices.

### BACKGROUND OF THE INVENTION

In this era of Internet, mobile devices are increasingly being used to access content. However, most content on the web are configured for presentation on full-function web browsers running on desktop computers. Owing to smaller display screens, limited processing power, limited memory, slower network speeds, constrained keyboard functionality, etc of the mobile devices compared to full-featured desktop counterparts, this content is not suitable for viewing on the mobile devices. The conversion of standard web pages for presentation of content on the mobile devices is a challenge as the amount of content contained within these web pages is oftentimes too large to be adequately displayed on the smaller screens of the mobile devices. In addition, different mobile devices have different characteristics and different constraints, which further make the display of different types of content on these mobile devices cumbersome.

One conventional approach for adapting web content to different mobile devices is to tailor the web content manually to suit the characteristics of the mobile devices at the web content development stage by the content publishers themselves. In other words, the content publishers have to create multiple renderings of the web content in different versions or different applications for each mobile device based on the display capability. In addition, the existence of a multitude of these mobile devices in the market, with each mobile device having different characteristics and different constraints renders this approach time consuming and rather tedious. Further, in some of the cases, web content rendered by the above means is incompatible with the mobile devices that have completely different characteristics.

In other conventional approach, content is prepared only for a specific type of device. In yet another conventional approach, the content publishers provide different websites for different mobile devices. For example, a mobile site for a mobile phone, a tablet site for a tablet computer, etc. However, the tablet site is typically an enlarged version of the mobile site and thereby does not provide a satisfactory viewing experience of the web content on the tablet site and vice versa.

In yet another conventional approach, the content publishers develop an application and then point users of a certain mobile device to that application. The users need to install the application on the mobile device to be able to view the web content adapted for their mobile device. In this approach, the control is not in the hands of the content publishers. The content publishers cannot ascertain that their customers using the mobile devices have installed the application for viewing the web content. Moreover, since it is an application, the look and feel of the web content are already built into the application and does not allow for further customization without developing downloadable updates to the installed applications.

In light of the above discussion, there exists a need for customizing the web content based on the characteristics of the mobile device in real time when the mobile device requests for the web content.

### SUMMARY OF THE INVENTION

This Summary is provided to introduce a selection of concepts in a simplified form that are further described below in the Detailed Description. This Summary is not intended to identify key or essential features of the invention, nor is it intended to be used as an aid in determining the scope of the invention.

The present invention provides a method for customizing web content for a mobile computing device associated with a user over a network. The method includes receiving a request for web content from the mobile computing device associated with the user and parsing acquired web content into separate one or more component parts based on the received request. The acquired web content is collected from a publisher of one or more publishers. Further, the method includes storing the separated one or more component parts individually for the publisher of the one or more publishers, determining display capability of a browsing entity residing on the mobile computing device and enabling customization of the separated one or more component parts of the web content based on the determined display capability. Accordingly, the user views the customized web content.

In an embodiment, the method includes checking availability of the requested web content and fetching the requested web content from the publisher of the one or more publishers.

In an embodiment, the display capability includes at least one of form factor of the mobile computing device, characteristics of the mobile computing device, features of the mobile computing device, attributes of the mobile computing device, browsing entity attributes of the mobile computing device and limitations of the mobile computing device. The form factor of the mobile computing device includes at least one of physical dimensions of display of the mobile computing device. The characteristics of the mobile computing device include at least one of script execution capabilities and multimedia handling capabilities. The browsing entity attributes of the mobile computing device includes at least one of script execution capabilities and multimedia handling capabilities.

In an embodiment, determining display capability of the browsing entity residing on the mobile computing device further includes detecting identification information of the requesting browsing entity from a user agent header contained in the received request for the web content and mapping the identification information of the requesting browsing entity against a database for determining the display capability of the browsing entity of the mobile computing device. In an embodiment, the identification information of the browsing entity includes at least one of name and version of the browsing entity and name and make of the mobile computing device.

In an embodiment, enabling customization of the separated one or more component parts of the web content based on the determined display capability further includes determining a level of rendering required for presentation of web content on the mobile computing device based on the determined display capability of the mobile computing device.

In an embodiment, parsing the acquired web content into separate one or more component parts is based on display options provided by the publisher of one or more publishers pertaining to presentation of the web content.

In another aspect, the present invention provides a method for customizing web content for a mobile computing device associated with a user over a network. The method includes receiving a request for web content from the mobile computing device associated with the user and acquiring the web content from a publisher of one or more publishers before or after receiving the request for the web content. Further, the method includes parsing the acquired web content into separate one or more component parts based on the received request and display options provided by the publisher of one or more publishers. Furthermore, the method includes storing the separated one or more component parts individually for the publisher of the one or more publishers, determining display capability of a browsing entity residing on the mobile computing device and enabling customization of the separated one or more component parts of the web content based on the determined display capability. Accordingly, the user views the customized web content.

In an embodiment, the display capability includes at least one of form factor of the mobile computing device, characteristics of the mobile computing device, features of the mobile computing device, attributes of the mobile computing device, browsing entity attributes of the mobile computing device and limitations of the mobile computing device. The form factor of the mobile computing device includes at least one of physical dimensions of display of the mobile computing device. The characteristics of the mobile computing device include at least one of script execution capabilities and multimedia handling capabilities. The browsing entity attributes of the mobile computing device includes at least one of script execution capabilities and multimedia handling capabilities.

In an embodiment, determining display capability of the browsing entity residing on the mobile computing device further includes detecting identification information of the requesting browsing entity from a user agent header contained in the received request for the web content and mapping the identification information of the requesting browsing entity against a database for determining the display capability of the browsing entity of the mobile computing device. In an embodiment, the identification information of the browsing entity includes at least one of name and version of the browsing entity and name and make of the mobile computing device.

In an embodiment, enabling customization of the separated one or more component parts of the web content based on the determined display capability further comprises determining a level of rendering required for presentation of web content on the mobile computing device based on the determined display capability of the mobile computing device.

In another aspect, a computer system for customizing web content for a mobile computing device associated with a user over a network is provided. The computer system includes one or more processors and a non-transitory memory containing instructions that, when executed by the one or more processors, causes the one or more processors to perform a set of steps. The set of steps includes receiving a request for web content from the mobile computing device associated with the user by the request processing module of a content customization platform of the computer system. Further, the set of steps includes parsing acquired web content into separate one or more component parts based on the received request by a data acquisition module of the content customization platform of the computer system. The acquired web content is collected from a publisher of one or more publishers. Furthermore, the set of steps includes storing the separated one or more component parts individually for the publisher of the one or more publishers by a data repository of the content customization platform of the computer system. Furthermore, the set of steps include determining display capability of a browsing entity residing on the mobile computing device by a device detection application of the content customization platform of the computer system. Moreover, the set of steps include enabling the separated one or more component parts of the web content based on the determined display capability by a response processing module in conjunction with the data acquisition module of the content customization platform of the computer system customization. Accordingly, the user views the customized web content.

In an embodiment, determining display capability of a browsing entity residing on the mobile computing device by the device detection application of the content customization platform of the computer system includes detecting identification information of the requesting browsing entity from a user agent header contained in the received request for the web content and mapping the identification information of the requesting browsing entity against a database for determining the display capability of the browsing entity of the mobile computing device.

Other aspects and example embodiments are provided in the drawings and the detailed description that follows.

### BRIEF DESCRIPTION OF THE DRAWINGS

For a more complete understanding of example embodiments of the present technology, reference is now made to the following descriptions taken in connection with the accompanying drawings in which:

FIG. 1 illustrates a system for customizing web content for a mobile device, in accordance with various embodiments of the present invention;

FIG. 2 illustrates a block diagram of a computer system having a content customization platform, in accordance with various embodiments of the present invention;

FIG. 3 illustrates various components of the content customization platform, in accordance with various embodiments of the present invention;

FIG. 4 illustrates a flow chart for displaying the web content, in accordance with an embodiment of the present invention; and

FIG. 5 illustrates a flow chart for displaying the web content, in accordance with another embodiment of the present invention.

### DETAILED DESCRIPTION OF THE INVENTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

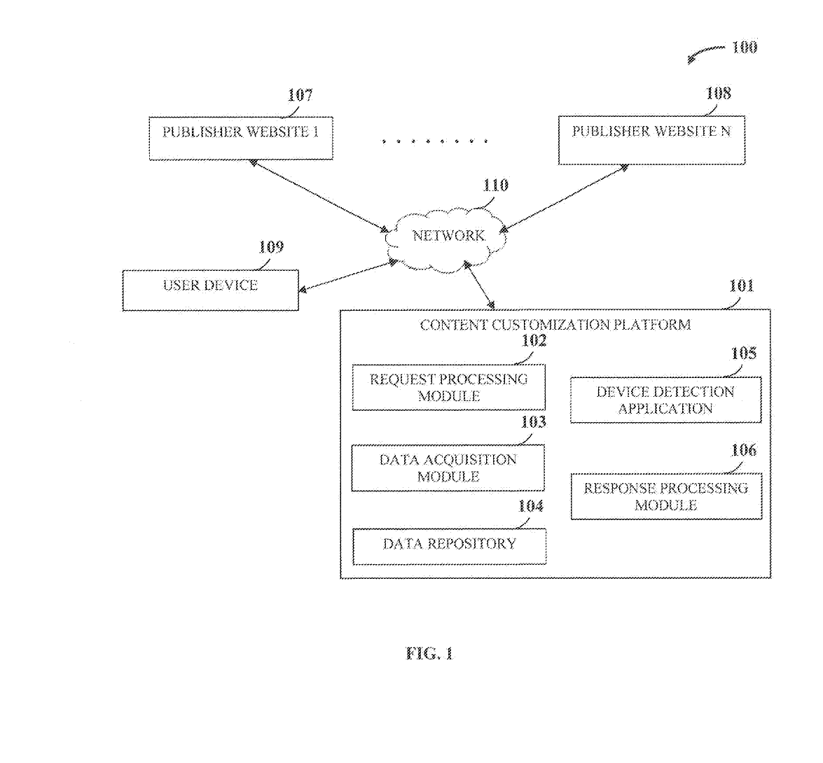

FIG. 1 illustrates a system 100 for customizing web content for a mobile device 112, in accordance with various embodiments of the present invention. The system 100 includes one or more publisher websites (shown as a publisher website 108 and a publisher website 110). In addition, the system 100 includes a user 114 accessing web content of the publisher website 108 and/or the publisher website 110 with the mobile device 112 through a network 102. In addition, a computer system 104 having a content customization platform 106 customizes the content of the publisher website 108 and/or the publisher website 110 through the network 102.

It may be noted that the term ‘web content’ refers to contents of a web page of the publisher website 108 or a web page of the publisher website 110. The web page refers to information resource that can be accessed through a web browser and displayed on the mobile device 112. The web page can have different type of information which may include but may not be limited to audio, video, images, and pictures. The look, feel, layout, design, etc. of the web page is provided by cascading style sheet (CSS) instructions. The CSS instructions refer to a language used for describing the presentation semantics of a document written in a markup language. In other words, the elements that contribute to the look and feel of a web page are provided by the CSS instructions.

As used herein, the term ‘the mobile device 112’ refers to a handheld electronic device that can be used to access the web page on the Internet. Examples of the mobile device 112 can include but may not be limited to a cell phone, a smart phone, a personal digital assistant (PDA), a wireless email terminal, a laptop, and a tablet computer.

As used herein, the term ‘the publisher website 108’ refers to a website that hosts web pages comprising the web content and having an association with the content customization platform 106. Similarly, the term ‘the publisher website 110’ refers to a website that hosts web pages comprising the web content and having an association with the content customization platform 106.

It may be noted that the system 100 is shown to have the publisher website 108 and the publisher website 110; however, those skilled in the art would appreciate that the system 100 can include one or more publisher website. In addition, it may also be noted that for the sake of simplicity, the present invention will be explained by referring to the publisher website 108; however, those skilled in the art would appreciate that the present invention can be exercised on one or more publisher websites.

The publisher website 108 associates with the content customization platform 106 of the computer system 104. For example, the publisher website 108 registers with the content customization platform 106 to customize the web content according to the mobile device 112. Similarly, the publisher website 110 (and other one or more publisher websites) registers with the content customization platform 106 to customize the web content according to the mobile device 112. It may also be noted that the present invention is explained to customize the web content of the publisher website 108 according to the mobile device 112; however, those skilled in the art would appreciate that web content of the publisher website 108 is customized according to the different mobile devices associated with different users. In addition, the web content of the publisher website 110 (and one or more publishers) is customized according to the different mobile devices associated with different users.

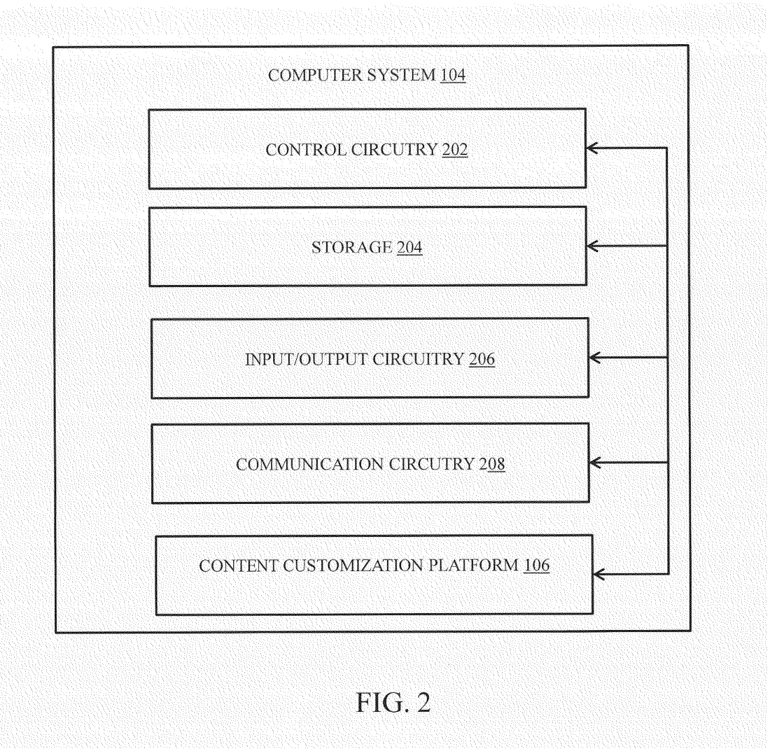

In an embodiment of the present invention, the web content of the publisher website 108 is customized by the content customization platform 106 residing in the computer system 104. As illustrated in the FIG. 2, the computer system 104 includes a control circuitry 202, a storage 204, an input/output (“I/O”) circuitry 206, a communications circuitry 208 and the content customization platform 106.

Those skilled in the art would appreciate that the computer system 104 of FIG. 2 may include one or more components which may not be shown here. These one or more components of the computer system 104 may be combined or omitted with the components shown in FIG. 2. The computer system 104 includes any suitable type of electronic device. Examples of the computer system 104 include but may not be limited to a digital media player (e.g., an iPod™ made available by Apple Inc. of Cupertino, Calif.), a personal e-mail device (e.g., a Blackberry™ made available by Research in Motion of Waterloo, Ontario), a personal data assistant (“PDA”), a cellular telephone, a Smartphone, a handheld gaming device, a digital camera, a laptop computer, and a tablet computer. In another embodiment of the present invention, the computer system 104 can be a desktop computer.

From the perspective of this invention, the control circuitry 202 includes any processing circuitry or processor operative to control the operations and performance of the computer system 104. For example, the control circuitry 202 may be used to run operating system applications, firmware applications, media playback applications, media editing applications, or any other application. In an embodiment, the control circuitry 202 drives a display and process inputs received from a user interface.

From the perspective of this invention, the storage 204 includes one or more storage mediums including a hard-drive, solid state drive, flash memory, permanent memory such as ROM, any other suitable type of storage component, or any combination thereof. The Storage 204 may store, for example, media data (e.g., music and video files), application data (e.g., for implementing functions on the computer system 104).

From the perspective of this invention, the I/O circuitry 206 may be operative to convert (and encode/decode, if necessary) analog signals and other signals into digital data. In an embodiment, the I/O circuitry 206 may also convert digital data into any other type of signal, and vice-versa. For example, the I/O circuitry 206 may receive and convert physical contact inputs (e.g., from a multi-touch screen), physical movements (e.g., from a mouse or sensor), analog audio signals (e.g., from a microphone), or any other input. The digital data may be provided to and received from the control circuitry 202, the storage 204, or any other component of the computer system 104.

It may be noted that the I/O circuitry 206 is illustrated in FIG. 2 as a single component of the computer system 104; however those skilled in the art would appreciate that several instances of the I/O circuitry 206 may be included in the computer system 104.

The computer system 104 may include any suitable interface or component for allowing a user to provide inputs to the I/O circuitry 206. The computer system 104 may include any suitable input mechanism. Examples of the input mechanism include but may not be limited to a button, keypad, dial, a click wheel, and a touch screen. In an embodiment, the computer system 104 may include a capacitive sensing mechanism, or a multi-touch capacitive sensing mechanism.

In an embodiment, the computer system 104 may include specialized output circuitry associated with output devices such as, for example, one or more audio outputs. The audio output may include one or more speakers built into the computer system 104, or an audio component that may be remotely coupled to the computer system 104.

The one or more speakers can be mono speakers, stereo speakers, or a combination of both. The audio component can be a headset, headphones or ear buds that may be coupled to communications device with a wire or wirelessly.

In an embodiment, the I/O circuitry 206 may include display circuitry for providing a display visible to the user. For example, the display circuitry may include a screen (e.g., an LCD screen) that is incorporated in the computer system 104.

The display circuitry may include a movable display or a projecting system for providing a display of content on a surface remote from the computer system 104 (e.g., a video projector). In an embodiment, the display circuitry may include a coder/decoder to convert digital media data into analog signals. For example, the display circuitry may include video Codecs, audio Codecs, or any other suitable type of Codec.

The display circuitry may include display driver circuitry, circuitry for driving display drivers, or both. The display circuitry may be operative to display content. The display content can include media playback information, application screens for applications implemented on the electronic device, information regarding ongoing communications operations, information regarding incoming communications requests, or device operation screens under the direction of the control circuitry 202. Alternatively, the display circuitry may be operative to provide instructions to a remote display.

From the prospective of this invention, a communications circuitry 208 may include any suitable communications circuitry operative to connect to a communications network and to transmit communications (e.g., voice or data) from the computer system 104 to other devices within the communications network. The communications circuitry 208 may be operative to interface with the communications network using any suitable communications protocol. Examples of the communications protocol include but may not be limited to Wi-Fi, Bluetooth®, radio frequency systems, infrared, LTE, GSM, GSM plus EDGE, CDMA, and quadband.

In an embodiment, the same instance of the communications circuitry 208 may be operative to provide for communications over several communications networks. In an embodiment, the computer system 104 may be coupled a host device for data transfers, synching the communications device, software or firmware updates, providing performance information to a remote source (e.g., providing riding characteristics to a remote server) or performing any other suitable operation that may require the computer system 104 to be coupled to a host device. Several computing devices may be coupled to a single host device using the host device as a server. Alternatively or additionally, the computer system 104 may be coupled to several host devices (e.g., for each of the plurality of the host devices to serve as a backup for data stored in the computer system 104).

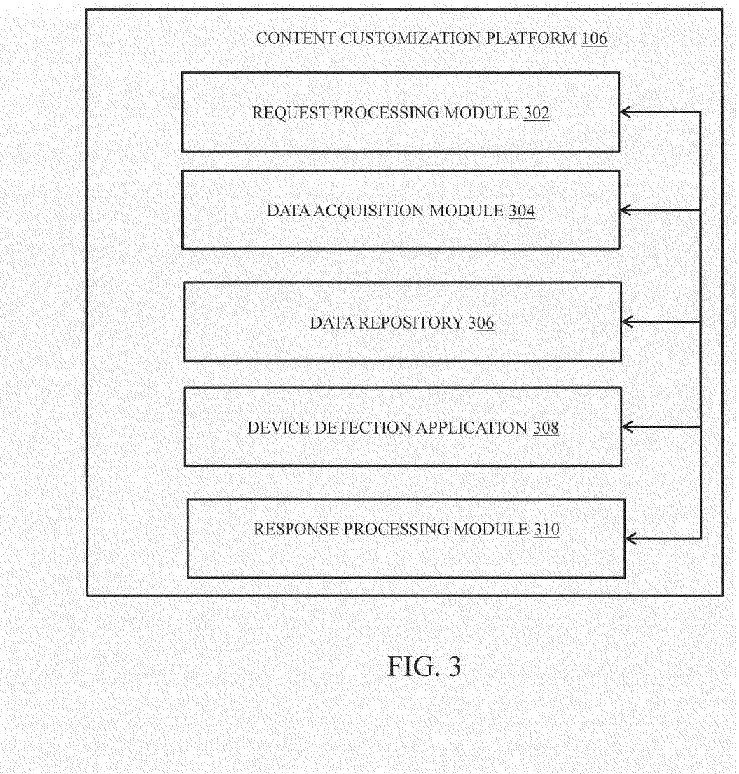

The content customization platform 106 of the computer system 104 enables the customization of the web content in conjunction with the control circuitry 202, the storage 204, the input/output circuitry 206 and the communication circuitry 208. As illustrated in FIG. 3, the content customization platform 106 includes a request processing module 302, a data acquisition module 304, a data repository 306, a device detection application 308, and a response processing module 310. Those skilled in the art would appreciate that the content customization platform 106 of FIG. 3 may include one or more components which may not be shown here. In addition, it may be noted that references will be made to the system elements of FIG. 1 and FIG. 2 to explain the various components along with their respective components of the content customization platform 106 shown in FIG. 3.

In an embodiment, the request processing module 302 receives a request for web content from the user 114 via a browsing entity residing in the mobile device 112. The browsing entity is one of a native application and a web browser. In an example, the browsing entity is a WebKit® browser on a Nokia® Lumia® 800. The term ‘native application’ refers to an application that is configured to run on the operating system and machine firmware of the mobile device 112. The term ‘web browser’ refers to a software application for retrieving, presenting, and accessing the web content on the World Wide Web from the mobile device 112. The user 114 may send the request for the web content from the mobile device 112 by typing the uniform resource locator (URL) of the desired website on the web browser of the mobile device 112. In other words, the web browser on the mobile device 112 initiates a Hypertext Transfer Protocol (HTTP) request for the web content.

The data acquisition module 304 acquires the requested web content from the publisher website 108 that hosts the web content. The content customization platform 106 communicates with the publisher website 108 via the network 102, such as the Internet, an intranet, etc. In an embodiment, the data acquisition module 304 periodically gathers the web content from one or more data sources of the publisher websites 108 registered with the content customization platform 106. Examples of the data sources include but may not be limited to Rich Site Summary (RSS) feeds and an application programming interface (API) on the website.

The mobile device 112 communicates with the content customization platform 106 via the Internet or an intranet, and connected through the network 102. Examples of the network 102 include but not may be limited to a local area network, a wide area network, a wireless network and a telecommunication network. Examples of the telecommunication network include but may not be limited to a global system for mobile communications (GSM) network, a general packet radio service (GPRS) network, a code division multiple access (CDMA) system, enhanced data GSM environment (EDGE), and wideband CDMA (WCDMA).

Following the acquisition of the web content from the publisher website 108, the data acquisition module 304 parses the acquired web content into separate one or more component parts. Examples of the component parts of the web content include but not limited to text, images, sounds, videos, animations. CSS instructions and publisher specific display options. The publisher specific display options refer to instructions specified by a publisher of the web content pertaining to presentation of the web content on the mobile device 112. As used herein, the term ‘publisher’ refers to the owner or creator of the web content. Some of the exemplary instructions can be but may not be limited to ‘whether to retain a brand name of the publisher on the web page’, ‘whether to include a privacy policy’, and ‘advertising information’.

The data acquisition module 304 stores the separated component parts individually in the data repository 306 of the content customization platform 106. The storing of the component parts of the web page individually enables complete control over how the web content is rendered by the content customization platform 106.

When the user 114 requests for the web content, the request processing module 302 checks if the requested web content is available in the data repository 306. If the web content is not available, the request for the web content is routed to the data acquisition module 304. The data acquisition module 304 acquires the requested web content from the publisher website 108, parses the acquired web content into separate component parts, and stores the parsed web content in the data repository 306. The requested web content is provided to the response processing module 310.

In response to the request received from the mobile device 112, the device detection application 308 determines display capability of the browsing entity residing on the mobile device 112. As used herein, the term ‘display capability’ refers to but may not be limited to a form factor, characteristics, features, device attributes, browsing entity attributes, and limitations of the browsing entity of the mobile device 112 through which the mobile device 112 requests for the web content. The term ‘form factor’ refers to the physical dimensions of the mobile device 112, such as height and width, screen size, and the like. Examples of the device attributes include but may not be limited to the script execution capabilities and the multimedia handling capabilities. Also, as used herein, the term ‘browsing entity attributes’ refers to the attributes and features of the browsing entity residing on the mobile device 112. Examples the attributes and features of the browsing entity residing on the mobile device 112 include but may not be limited to the script execution capabilities and multimedia handling capabilities. In an embodiment, the ‘display capability’ of a browsing entity in the mobile device 112 represents the presentation of the web content on the mobile device 112 owing to constraints exhibited by at least one of the browsing entity and the mobile device 112.

The device detection application 308 is configured to communicate with a device database in order to acquire the display capability of the browsing entity on the mobile device 112. The ‘device database’ refers to a database including a list of all available browsing entities and user devices and their corresponding browsing entity attributes and device attributes. the single mobile device 112 may host multiple browsing entities each having a corresponding set of browsing entity attributes. The device database includes information about the attributes of each of the user devices and each of the browsing entities operating on the user devices. Example of the device database include but may not be limited to a DeviceAtlas®, of Top Level Domain Limited Corporation and is placed on top of the content customization platform 106. In an embodiment, the device database is stored in the data repository 306 of the content customization platform 106. In another embodiment, the device database is hosted on a cloud based environment and communicates with the content customization platform 106 via the network 102. In yet another embodiment, the device database is provided as a component in the content customization platform 106.

Further, the device detection application 308 includes an Application Programming Interface (API) that enables the device detection application 308 to detect identification information of the requesting browsing entity and to determine the display capability of the browsing entity. As used herein, the term ‘requesting browsing entity’ refers to the browsing entity residing on the mobile device 112 that initiates the request for the web content. The device detection application 308 detects the identification information of the requesting browsing entity from the user agent header contained in the request. In an embodiment, the identification information of the browsing entity includes but not be limited to name and version of the browsing entity and name and make of the mobile device 112.

The device detection application 308 maps the identification information of the requesting browsing entity against the device database for determining the display capability of the browsing entity. For every HTTP request received from a browsing entity, the device detection application 308 determines the display capability using the device database. In an example, the identification information received from the browsing entity is a WebKit® browser on a Nokia® Lumia® 800 and the device detection application 308 matches it to its corresponding specifications, for example, display size, memory, processing power, network speeds, keyboard functionality, etc.

The response processing module 310 coupled to the request processing module 302 adapts the separated component parts of the web content in accordance with the determined display capability of the mobile device 112. The response processing module 310 renders the web content based on the display capability. For example, the response processing module 310 renders the web content based on the form factor, the script, CSS capabilities, and the like of the browsing entity residing on the mobile device 112.

In an embodiment, the web content is rendered based on two sets of variables. In this embodiment, one set of variables refer to the determined display capability and the other set of variables refer to customization parameters specified by the publishers. As used herein, the term ‘customization parameters’ refer to variables specified by the publisher of the web content pertaining to the presentation schematics or styling elements (say look and feel of a webpage). In other words, a publisher may wish to present a web page in a certain way on the particular mobile device 112 and may specify the customization parameters to the content customization platform 106 accordingly. The customization parameters are acquired from the publisher website 108. For example, the customization parameters may include information regarding whether the publisher wishes to incorporate Twitter® feed into the website, whether the publisher wants to integrate Facebook® comments into the website, whether the publisher wants to display the company logo, or wants the web content to be paginated, and the like. The term ‘pagination’ refers to a process of dividing the web content into discrete pages.

In an example, depending on the type of CSS execution capabilities of the mobile device 112, the CSS files suitable for rendering the web content is loaded on the mobile device 112. The CSS files are stored on the content customization platform 106. For example, CSS 3 is used for rendering the web content on high end user devices. The simple CSS attributes and styling elements is used for user devices with limited features. In other words, if the mobile device 112 does not support certain features to display the web content, the web page is downgraded based on the determined display capability. The content customization platform 106 takes a call on the features to be downgraded. Therefore, the transfer of web content between the publisher website 108 and the mobile device 112 is optimized so that no unnecessary data is transmitted to the mobile device 112.

In an embodiment, the content customization platform 106 provides custom themes and allows complete control over the elements of the web page to be presented on the mobile device 112. Examples of the elements of the web page include but may not be limited to menus, submenus and article priorities. Finally, the adapted web content is served to the mobile device 112 by the content customization platform 106. In an embodiment, the response processing module 310 determines a level of rendering required for presentation on the mobile device 112 based on the determined display capability.

In an embodiment, the rendering is performed by the content customization platform 106 and the final web content to be displayed on the mobile device 112 is sent to the mobile device 112. In another embodiment, the system 100 provides the web content to the mobile device 112 and enables the rendering to take place on the mobile device 112. The mobile device 112 may perform the rendering using a web template system. In this embodiment, the mobile device 112 is typically a high end the mobile device 112, for example, iPad® of Apple® Inc. The web template system refers to software and methodologies used to produce web pages and for deployment on websites and delivery over the Internet. Examples of the web template system include but may not be limited to JavaScript® Mustache, Jquery® mobile, Backbone.js and the like. Although illustrated as separate functions, the rendering and display functions can be arranged or divided in different ways to run on either the content customization platform 106, the mobile device 112, or both the content customization platform 106 and the mobile device 112.

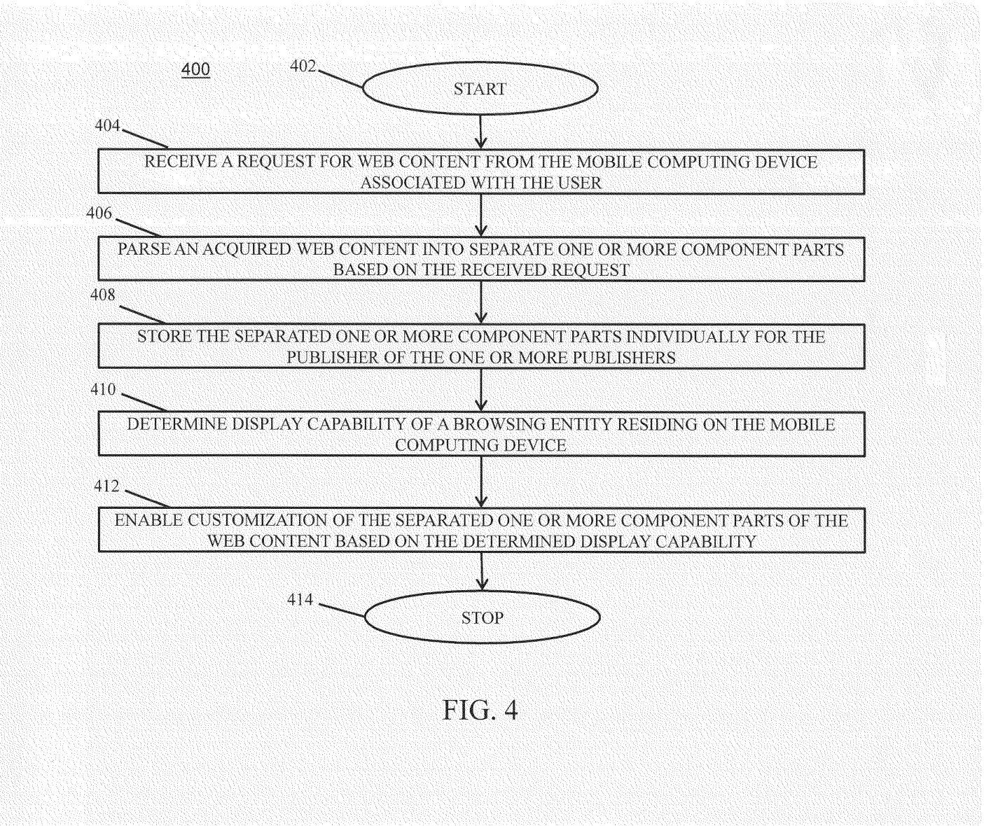

FIG. 4 illustrates a flow chart 400 for customizing web content for display on the mobile device 112, in accordance with an embodiment of the present invention. It may be noted that to explain the flow chart 400, direct or indirect references will be made to FIG. 1, FIG. 2 and FIG. 3. The flow chart initiates at step 402. At step 404, in an aspect of the present invention, the content customization platform 106 receives a request for web content from the mobile device 112 associated with the user 114. In an embodiment, the content customization platform 106 gathers the web content from one or more data sources of the publisher websites 108 registered with the content customization platform 106. In an embodiment, as explained above, the content customization platform 106 checks availability of the requested web content. If the requested web content is not available, the content customization platform 106 fetches the web content from the publisher. At step 406, in this aspect of the present invention, the content customization platform 106 parses the acquired web content into separate one or more component parts based on the received request. At step 408, in an aspect of the present invention, the content customization platform 106 stores the separated one or more component parts individually for the publisher website 108 of the one or more publisher websites (say the publisher website 108 and the publisher websites 110). At step 410, the content customization platform 106 determines the display capability of a browsing entity residing on the mobile device 112. In an embodiment, as explained above, the display capability includes at least one of form factor of the mobile device 112, characteristics of the mobile device 112, features of the mobile device 112, attributes of the mobile device 112, browsing entity attributes of the mobile device 112 and limitations of the mobile device 112. In an embodiment, as explained above, the form factor of the mobile device 112 includes at least one of physical dimensions of display of the mobile device 112. In an embodiment, as explained above, the characteristics of the mobile device 112 include at least one of script execution capabilities and multimedia handling capabilities. In an embodiment, as explained above, the browsing entity attributes of the mobile device 112 includes at least one of script execution capabilities and multimedia handling capabilities. In an embodiment, as explained above, the step of determining the display capability of the browsing entity residing on the mobile device 112 includes detecting identification information of the requesting browsing entity from a user agent header contained in the received request for the web content and mapping the identification information of the requesting browsing entity against a database for determining the display capability of the browsing entity of the mobile computing device. In an embodiment, the identification information of the browsing entity includes at least one of name and version of the browsing entity and name and make of the mobile device 112.

At step 412, the content customization platform 106 enables customization of the separated one or more component parts of the web content based on the determined display capability. In an embodiment, as explained above, enabling customization of the separated one or more component parts of the web content based on the determined display capability includes determining a level of rendering required for presentation of web content on the mobile device 112. At step 414, the flow chart 400 terminates. It may be noted that the flow chart 400 may include more or less number of steps and may follow the given sequence or may change the sequence of steps which lies within the scope of the present invention.

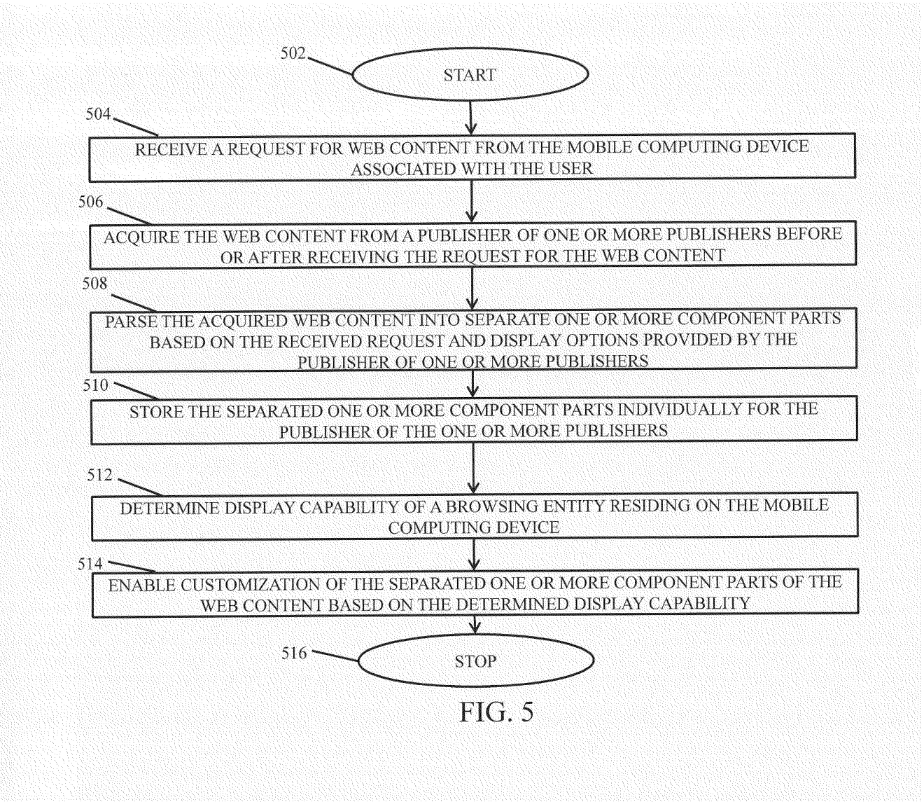

FIG. 5 illustrates a flow chart 500 for customizing web content for display on the mobile device 112, in accordance with another embodiment of the present invention. It may be noted that to explain the flow chart 500, direct or indirect references will be made to FIG. 1. FIG. 2, FIG. 3 and FIG. 4. The flow chart initiates at step 502. At step 504, in another aspect of the present invention, the content customization platform 106 receives a request for web content from the mobile device 112 associated with the user 114. In an embodiment, at step 506, the content customization platform 106 gathers the web content from one or more data sources of the publisher websites 108 registered with the content customization platform 106. In an embodiment, as explained above, the content customization platform 106 checks availability of the requested web content. If the requested web content is not available, the content customization platform 106 fetches the web content from the publisher. At step 508, in this aspect of the present invention, the content customization platform 106 parses the acquired web content into separate one or more component parts based on the received request and display options provided by a publisher of the publisher website 108. At step 510, in an aspect of the present invention, the content customization platform 106 stores the separated one or more component parts individually for the publisher website 108 of the one or more publisher websites (say the publisher website 108 and the publisher websites 110). At step 512, the content customization platform 106 determines the display capability of the browsing entity residing on the mobile device 112. In an embodiment, as explained above, the display capability includes at least one of form factor of the mobile device 112, characteristics of the mobile device 112, features of the mobile device 112, attributes of the mobile device 112, browsing entity attributes of the mobile device 112 and limitations of the mobile device 112. In an embodiment, as explained above, the form factor of the mobile device 112 includes at least one of physical dimensions of display of the mobile device 112. In an embodiment, as explained above, the characteristics of the mobile device 112 include at least one of script execution capabilities and multimedia handling capabilities. In an embodiment, as explained above, the browsing entity attributes of the mobile device 112 includes at least one of script execution capabilities and multimedia handling capabilities. In an embodiment, as explained above, the step of determining the display capability of the browsing entity residing on the mobile device 112 includes detecting identification information of the requesting browsing entity from a user agent header contained in the received request for the web content and mapping the identification information of the requesting browsing entity against a database for determining the display capability of the browsing entity of the mobile computing device. In an embodiment, the identification information of the browsing entity includes at least one of name and version of the browsing entity and name and make of the mobile device 112.

At step 514, the content customization platform 106 enables customization of the separated one or more component parts of the web content based on the determined display capability. In an embodiment, as explained above, enabling customization of the separated one or more component parts of the web content based on the determined display capability includes determining a level of rendering required for presentation of web content on the mobile device 112. At step 516, the flow chart 500 terminates. It may be noted that the flow chart 500 may include more or less number of steps and may follow the given sequence or may change the sequence of steps which lies within the scope of the present invention.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for customizing web content for a mobile computing device associated with a user over a network, the method comprising:
receiving a request for web content from said mobile computing device associated with said user;
parsing an acquired web content into separate one or more component parts based on said received request, wherein said acquired web content is collected from a publisher of one or more publishers;
storing said separated one or more component parts individually for said publisher of said one or more publishers;
determining display capability of a browsing entity residing on said mobile computing device; and
enabling customization of said separated one or more component parts of said web content based on said determined display capability, wherein said user views said customized web content.

2. The method as recited in claim 1, further comprising:
checking availability of said requested web content; and
fetching said requested web content from said publisher of said one or more publishers.

3. The method as recited in claim 1, wherein said display capability comprises at least one of form factor of said mobile computing device, characteristics of said mobile computing device, features of said mobile computing device, attributes of said mobile computing device, browsing entity attributes of said mobile computing device and limitations of said mobile computing device.

4. The method as recited in claim 3, wherein said form factor of said mobile computing device comprises at least one of physical dimensions of display of said mobile computing device.

5. The method as recited in claim 4, wherein said characteristics of said mobile computing device comprises at least one of script execution capabilities and multimedia handling capabilities.

6. The method as recited in claim 4, wherein said browsing entity attributes of said mobile computing device comprises at least one of script execution capabilities and multimedia handling capabilities.

7. The method as recited in claim 1, wherein determining display capability of said browsing entity residing on said mobile computing device further comprises:
detecting identification information of said requesting browsing entity from a user agent header contained in said received request for said web content; and
mapping said identification information of said requesting browsing entity against a database for determining said display capability of said browsing entity of said mobile computing device.

8. The method as recited in claim 7, wherein said identification information of said browsing entity comprises at least one of name and version of said browsing entity and name and make of said mobile computing device.

9. The method as recited in claim 1, wherein enabling customization of said separated one or more component parts of said web content based on said determined display capability further comprises determining a level of rendering required for presentation of web content on said mobile computing device based on said determined display capability of said mobile computing device.

10. The method as recited in claim 1, wherein parsing said acquired web content into separate one or more component parts is based on display options provided by said publisher of one or more publishers pertaining to presentation of said web content.

11. A method for customizing web content for a mobile computing device associated with a user over a network, the method comprising:
receiving a request for web content from said mobile computing device associated with said user;
acquiring said web content from a publisher of one or more publishers before or after receiving said request for said web content;
parsing said acquired web content into separate one or more component parts based on said received request and display options provided by said publisher of one or more publishers;
storing said separated one or more component parts individually for said publisher of said one or more publishers;
determining display capability of a browsing entity residing on said mobile computing device; and
enabling customization of said separated one or more component parts of said web content based on said determined display capability, wherein said user views said customized web content.

12. The method as recited in claim 11, wherein said display capability comprises at least one of form factor of said mobile computing device, characteristics of said mobile computing device, features of said mobile computing device, attributes of said mobile computing device, browsing entity attributes of said mobile computing device and limitations of said mobile computing device.

13. The method as recited in claim 12, wherein said form factor of said mobile computing device comprises at least one of physical dimensions of display of said mobile computing device.

14. The method as recited in claim 12, wherein said characteristics of said mobile computing device comprises at least one of script execution capabilities and multimedia handling capabilities.

15. The method as recited in claim 12, wherein said browsing entity attributes of said mobile computing device comprises at least one of script execution capabilities and multimedia handling capabilities.

16. The method as recited in claim 11, wherein determining display capability of said browsing entity residing on said mobile computing device further comprises:
detecting identification information of said requesting browsing entity from a user agent header contained in said received request for said web content; and
mapping said identification information of said requesting browsing entity against a database for determining said display capability of said browsing entity of said mobile computing device.

17. The method as recited in claim 16, wherein said identification information of said browsing entity comprises at least one of name and version of said browsing entity and name and make of said mobile computing device.

18. The method as recited in claim 11, wherein enabling customization of said separated one or more component parts of said web content based on said determined display capability further comprises determining a level of rendering required for presentation of web content on said mobile computing device based on said determined display capability of said mobile computing device.

19. A computer system for customizing web content for a mobile computing device associated with a user over a network, the system comprising:
one or more processors; and
a non-transitory memory containing instructions that, when executed by said one or more processors, causes said one or more processors to perform a set of steps comprising:
receiving, by a request processing module of a content customization platform of said computer system, a request for web content from said mobile computing device associated with said user;
parsing, by a data acquisition module of said content customization platform of said computer system, an acquired web content into separate one or more component parts based on said received request, wherein said acquired web content is collected from a publisher of one or more publishers;
storing, by a data repository of said content customization platform of said computer system, said separated one or more component parts individually for said publisher of said one or more publishers;
determining, by a device detection application of said content customization platform of said computer system, display capability of a browsing entity residing on said mobile computing device; and
enabling, by a response processing module in conjunction with said data acquisition module of said content customization platform of said computer system customization, of said separated one or more component parts of said web content based on said determined display capability, wherein said user views said customized web content.

20. The system as recited in claim 19, wherein determining, by said device detection application of said content customization platform of said computer system, display capability of a browsing entity residing on said mobile computing device further comprises:
detecting identification information of said requesting browsing entity from a user agent header contained in said received request for said web content; and
mapping said identification information of said requesting browsing entity against a database for determining said display capability of said browsing entity of said mobile computing device.
